(19) United States
(12) Patent Application Publication
(10) Pub. No.: US 2012/0127119 A1
(43) Pub. Date: May 24, 2012

(54) TOUCH SYSTEM CAPABLE OF REFRESHING AN OPERATION FREQUENCY OF A PROCESSOR AND METHOD THEREOF

(76) Inventors: Yu-Hung Li, Taoyuan County (TW); Pin-Hung Chou, Taipei City (TW)

(21) Appl. No.: 12/986,188

(22) Filed: Jan. 7, 2011

(30) Foreign Application Priority Data
Nov. 22, 2010 (TW) 099140181

(51) Int. Cl. G06F 3/045; G06F 3/042; G06F 3/041

(52) U.S. Cl. 345/174; 345/173; 345/175

(57) ABSTRACT

A method of refreshing an operation frequency of a processor includes detecting a number of objects touching a touch panel, refreshing the operation frequency of the processor according to the number of the objects touching the touch panel, detecting a number of following objects touching the touch panel according to the refreshed operation frequency of the processor, calculating coordinates of the objects touching the touch panel, and outputting the coordinates of the objects to a touch system.

### BACKGROUND OF THE INVENTION

1. Field of the Invention

The present invention is related to a touch system and method thereof, and particularly to a touch system capable of refreshing an operation frequency of a processor and method thereof.

2. Description of the Prior Art

Please refer to FIG. 1A and FIG. 1B. FIG. 1A is a diagram illustrating an object moving on a touch panel according to the prior art, and FIG. 1B is a diagram illustrating two or more objects moving on the touch panel according to the prior art. When the touch panel detects a number of objects touching the touch panel, an operation frequency of a processor of the touch panel is about 125 Hz, that is to say, the touch panel provides a 125 Hz report rate. When only one object moves on the touch panel, the 125 Hz operation frequency of the processor is sufficient for calculating a moving trace of the object. As shown in FIG. 1A, the motion trace of the object on the touch panel is smooth. However, as shown in FIG. 1B, when two or more objects move on the touch panel, the report rate of the processor is decreased, because the processor consumes double or more time to calculate motion traces of the two or more objects at the same time, resulting in rough motion traces of the two or more objects. Thus, when two or more objects move on the touch panel, touch performance of the touch panel is decreased.

### SUMMARY OF THE INVENTION

An embodiment provides a touch system capable of refreshing an operation frequency of a processor. The touch system includes a touch panel, at least one read out unit, and a processor. The touch panel is used for being touched by at least one object. The read out unit is used for detecting a number of objects touching the touch panel. The processor is used for refreshing the operation frequency of the processor according to the number of the objects touching the touch panel, calculating coordinates of the objects touching the touch panel according to the refreshed operation frequency of the processor, and outputting the coordinates of the objects touching the touch panel.

Another embodiment provides a method of refreshing an operation frequency of a processor. The method includes at least one read out unit detecting a number of objects touching a touch panel, refreshing the operation frequency of the processor according to the number of the objects touching the touch panel; detecting a number of following objects touching the touch panel according to the refreshed operation frequency of the processor; calculating coordinates of the objects touching the touch panel; and outputting the coordinates of the objects to a touch system.

The present invention provides a touch system capable of refreshing an operation frequency of a processor and method thereof. The touch system capable of refreshing the operation frequency of the processor and method thereof refresh the operation frequency of the processor according to a number of objects touching the touch panel, so a report rate of the touch panel can be kept by the operation frequency of the processor varying with the number of the objects touching the touch panel. Thus, the present invention can improve rough motion traces of the objects touching the touch panel of the prior art due to the decreased report rate by keeping the report rate of the touch panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram illustrating an object moving on a touch panel according to the prior art.

FIG. 1B is a diagram illustrating two or more objects moving on the touch panel according to the prior art.

FIG. 2 is a diagram illustrating a touch system capable of refreshing an operation frequency of a processor according an embodiment.

FIG. 3 and FIG. 4 are diagrams illustrating the read out unit detecting the number of the objects touching the touch panel.

FIG. 5 is a flowchart illustrating a method of refreshing an operation frequency of a processor according to another embodiment.

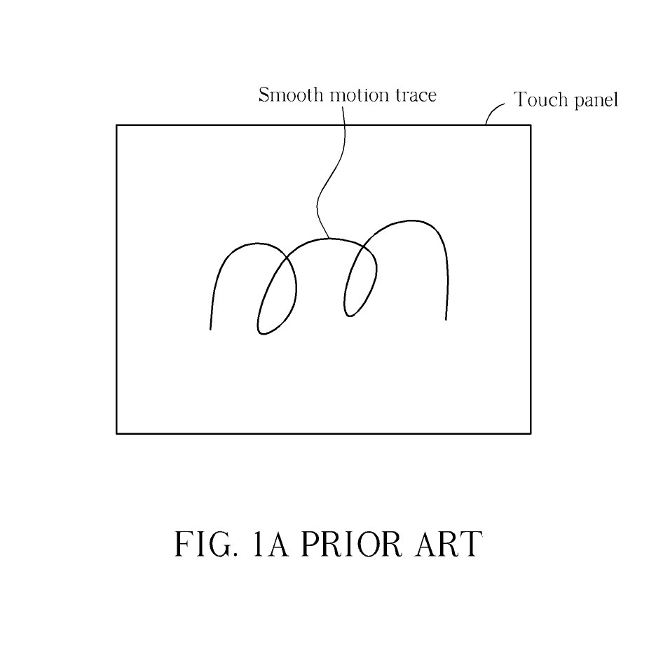

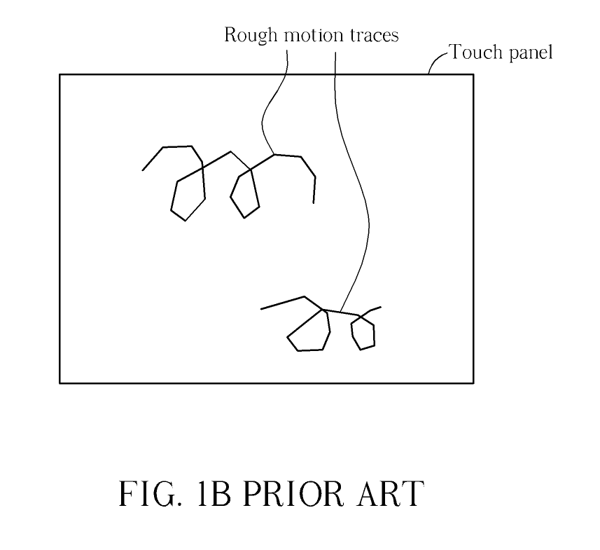

### DETAILED DESCRIPTION

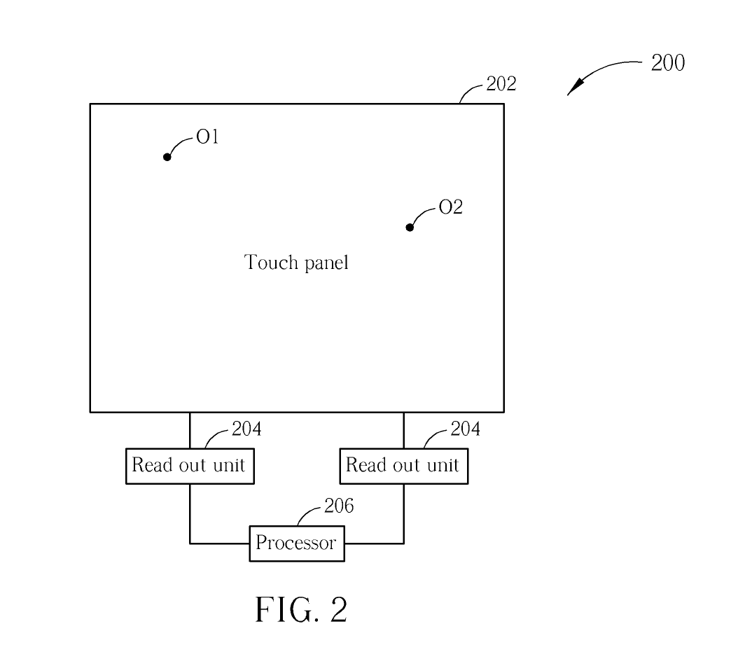

Please refer to FIG. 2. FIG. 2 is a diagram illustrating a touch system 200 capable of refreshing an operation frequency of a processor according an embodiment. The touch system 200 includes a touch panel 202, at least one read out unit 204, and a processor 206. The touch panel 202 is used for being touched by at least one object O1, O2. But the present invention is not limited to the touch panel 202 being touched by only two objects O1, O2. The read out unit 204 is used for detecting a number of objects touching the touch panel 202. The processor 206 is coupled to the read out unit 204 for refreshing an operation frequency OF of the processor 206 according to the number of the objects touching the touch panel 202, calculating coordinates of the objects touching the touch panel 202 according to the refreshed operation frequency OF of the processor, and outputting the coordinates of the objects touching the touch panel 202, where the touch panel 202 is a resistive touch panel, a capacitive touch panel, or an optical touch panel. In addition, the present invention is not limited to a number of the read out units 204 in FIG. 2; the number of the read out units 204 can change with a size of the touch panel 202.

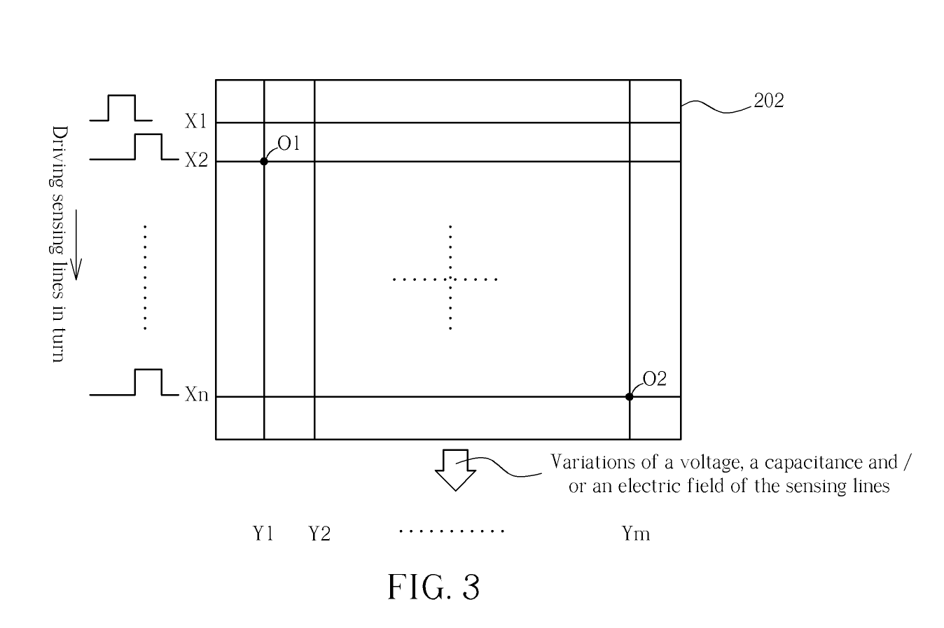

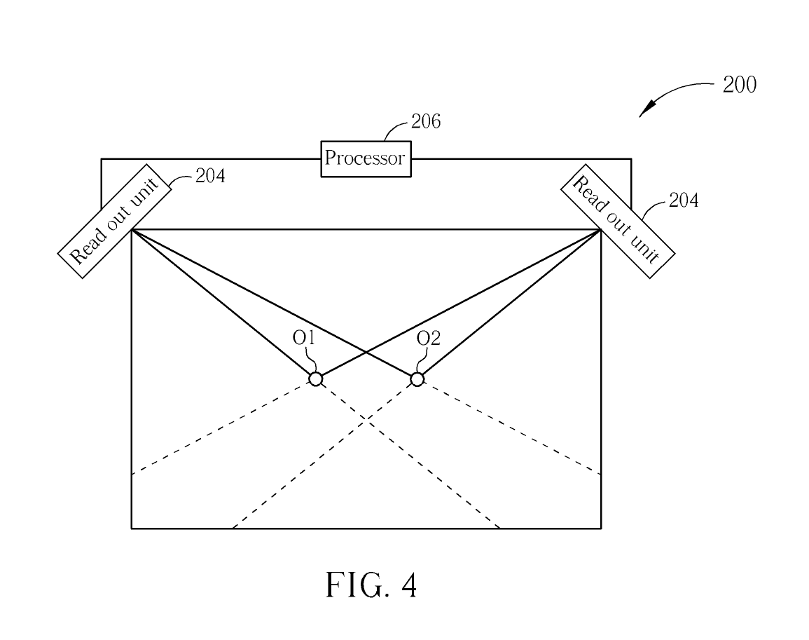

Please refer to FIG. 3 and FIG. 4. FIG. 3 and FIG. 4 are diagrams illustrating the read out unit 204 detecting the number of the objects touching the touch panel 202. As shown in FIG. 3, the read out unit 204 drives sensing lines X1-Xn in turn in a vertical direction of the touch panel 202, and the read out unit 204 senses sensing lines Y1-Ym in turn in a horizontal direction of the touch panel 202. That is to say, when the read out unit 204 drives the sensing line X1, the read out unit 204 senses each sensing line of the sensing lines Y1-Ym in turn; when the read out unit 204 drives the sensing line X2, the read out unit 204 senses each sensing line of the sensing lines Y1-Ym in turn, and so on. But the present invention is not limited to the read out unit 204 driving the sensing lines X1-Xn and sensing the sensing lines Y1-Ym. That is to say, the read out unit 204 can also drive the sensing lines Y1-Ym and sense the sensing lines X1-Xn. Therefore, when the read out unit 204 drives the sensing line Y1, the read out unit 204 senses each sensing line of the sensing lines X1-Xn in turn; when the read out unit 204 drives the sensing line Y2, the read out unit 204 senses each sensing line of the sensing lines X1-Xn in turn, and so on. In addition, as shown in FIG. 3, when the touch panel 202 is the resistive touch panel or the capacitive touch panel, the read out unit 204 determines the two objects O1, O2 touching the touch panel 202 according to variations of a voltage, a capacitance and/or an electric field of the sensing lines X1-Xm, Y1-Ym of the touch panel 202. But the present invention is not limited to the touch panel 202 being touched by only two objects O1, O2. As shown in FIG. 4, when the touch panel 202 is the optical touch panel, the read out unit 204 transmits light to detect the number of the objects touching the touch panel 202, so the touch panel 202 can determine the number of the objects touching the touch panel 202 according to a variation of an optical path of the touch panel 202. As shown in FIG. 4, the read out unit 204 determines the two objects block the light transmitted by the read out unit 204 according to variations of the optical paths of the touch panel 202.

The processor 206 is used for refreshing the operation frequency OF according to the number of the objects touching the touch panel 202 detected by the read out unit 204. The processor 206 calculates positions of the objects touching the touch panel 202 according to the refreshed operation frequency and outputs corresponding coordinates of the objects touching the touch panel 202. For example, when an object touches the touch panel 202, the processor 206 keeps the operation frequency OF; when two objects touch the touch panel 202, the processor 206 refreshes the operation frequency OF to a double operation frequency 2*OF; when three objects touch the touch panel 202, the processor 206 refreshes the operation frequency OF to a triple operation frequency 3*OF. Therefore, a report rate of the touch panel 202 can be kept by the operation frequency of the processor 206 varying with the number of the objects touching the touch panel 202.

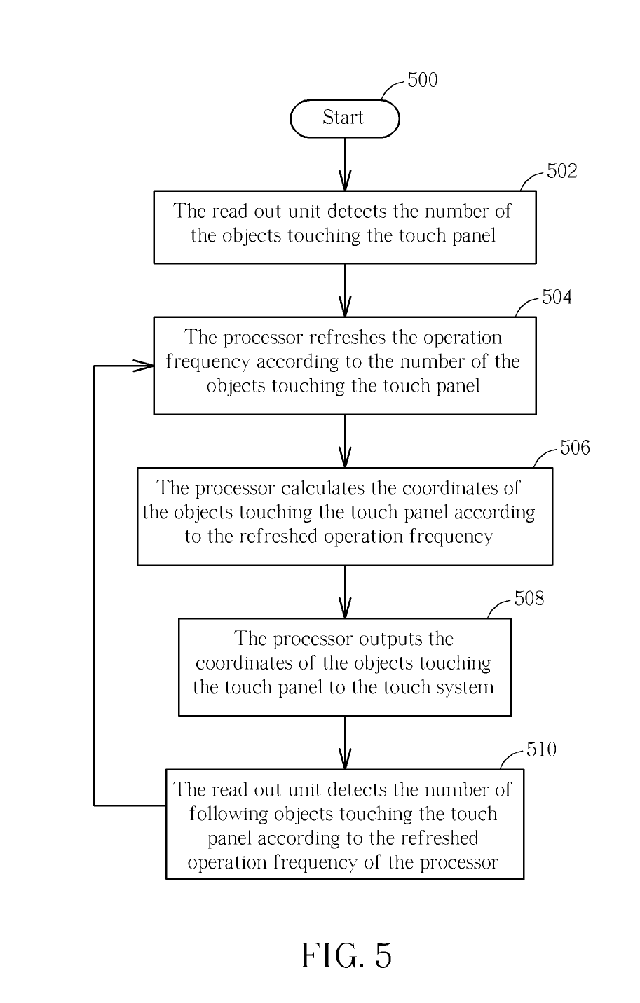

Please refer to FIG. 5. FIG. 5 is a flowchart illustrating a method of refreshing an operation frequency of a processor according to another embodiment. The method in FIG. 5 is illustrated with reference to touch system 200 in FIG. 2. Detailed steps are as follows:

Step 500: Start.

Step 502: The read out unit 202 detects the number of the objects touching the touch panel 202.

Step 504: The processor 206 refreshes the operation frequency OF according to the number of the objects touching the touch panel 202.

Step 506: The processor 206 calculates the coordinates of the objects touching the touch panel 202 according to the refreshed operation frequency.

Step 508: The processor 206 outputs the coordinates of the objects touching the touch panel 202 to the touch system 200.

Step 510: The read out unit 204 detects the number of following objects touching the touch panel 202 according to the refreshed operation frequency of the processor 206; go to Step 504.

In Step 506, the processor 206 calculates the coordinates of the objects touching the touch panel 202 according to the refreshed operation frequency. Therefore, the report rate of the touch panel 202 can be kept by the operation frequency of the processor 206 varying with the number of the objects touching the touch panel 202. In Step 508, the processor 206 outputs the coordinates of the objects touching the touch panel 202 to the touch system 200. Because the operation frequency of the processor 206 is increased, the motion traces of the objects touching the touch panel 202 are smoother. In Step 510, the read out unit 202 detects the number of the following objects touching the touch panel 202 according to the refreshed operation frequency of the processor 206, and the method returns to Step 504.

To sum up, the touch system capable of refreshing the operation frequency of the processor and method thereof refresh the operation frequency of the processor according to the number of the objects touching the touch panel, so the report rate of the touch panel can be kept by the operation frequency of the processor varying with the number of the objects touching the touch panel. Thus, the present invention can improve the rough motion traces of the objects touching the touch panel of the prior art due to the decreased report rate of the prior art by keeping the report rate of the touch panel.

Those skilled in the art will readily observe that numerous modifications and alterations of the device and method may be made while retaining the teachings of the invention.

What is claimed is:

1. A touch system capable of refreshing an operation frequency of
a processor, the touch system comprising:
a touch panel for being touched by at least one object;
at least one read out unit for detecting a number of objects touching the touch panel; and
a processor for refreshing the operation frequency of the processor according to the number of the objects touching the touch panel, calculating coordinates of the objects touching the touch panel according to the refreshed operation frequency of the processor, and outputting the coordinates of the objects touching the touch panel.

2. The touch system of claim 1, wherein the touch panel is an optical touch panel.

3. The touch system of claim 1, wherein the touch panel is a resistive touch panel.

4. The touch system of claim 1, wherein the touch panel is a capacitive touch panel.

5. A method of refreshing an operation frequency of a processor, the method comprising:
at least one read out unit detecting a number of objects touching a touch panel;
refreshing the operation frequency of the processor according to the number of the objects touching the touch panel;
detecting a number of following objects touching the touch panel according to the refreshed operation frequency of the processor;
calculating coordinates of the objects touching the touch panel; and
outputting the coordinates of the objects to a touch system.

6. The method of claim 5, wherein detecting the number of the objects touching the touch panel is detecting the number of the objects touching the touch panel according to a variation of a voltage of the touch panel.

7. The method of claim 5, wherein detecting the number of the objects touching the touch panel is detecting the number of the objects touching the touch panel according to a variation of a capacitance of the touch panel.

8. The method of claim 5, wherein detecting the number of the objects touching the touch panel is detecting the number of the objects touching the touch panel according to a variation of an electric field of the touch panel.

9. The method of claim 5, wherein detecting the number of the objects touching the touch panel is detecting the number of the objects touching the touch panel according to a variation of an optical path of the touch panel.
